(19) United States
(12) Patent Application Publication
(10) Pub. No.: US 2005/0079354 A1
(43) Pub. Date: Apr. 14, 2005

(54) Nano-graphite spherical material and method for preparation thereof

(76) Inventors: Sumio Iijima, Aichi (JP); Masako Yudasaka, Ibaraki (JP); Fumio Kokai, Ibaraki (JP); Kunimitsu Takahashi, Chiba (JP)

Correspondence Address: WENDEROTH, LIND & PONACK, L.L.P., 2033 K STREET N. W., SUITE 800, WASHINGTON, DC, 20006-1021, US

(21) Appl. No.: 10/500,798

(22) PCT Filed: Dec. 19, 2002
(86) PCT No.: PCT/JP02/13304

(30) Foreign Application Priority Data
Jan. 8, 2002 (JP) 2002-1848

(51) Int. Cl. B29C 35/08; B29C 39/00; B32B 9/00

(52) U.S. Cl. 428/408; 264/15; 264/400; 264/482; 264/163; 264/341; 428/402; 977/DIG. 1

(57) ABSTRACT

A graphite nanosphere which has a structure wherein a plurality of pyramids of multilayer graphite are arranged without clearance, taking their apexes as a center and the external form thereof is nearly spherical as a whole or as a part; and a method for preparing the graphite nanosphere which comprises irradiating a carbon target with a CO₂ laser in an inert gas atmosphere under a pressure of 5 to 10 atm to thereby generate the carbon in an atomic or cluster form having a temperature of no less than 1000° C.

### TECHNICAL FIELD

The invention relates to graphite nanospheres and a method for preparing the same. In particular, the invention relates to chemically stable and soft graphite nanospheres that are fine spherical particles with a size of nanometer order and are useful as abrasives and lubricants, and a method for preparing the graphite nanospheres that are able to be produced with their diameters and shapes controlling.

### BACKGROUND ART

Fine spherical particles of nanometer order formed of metals, ceramics and polymers have been used as abrasives and lubricants.

The fine spherical particles made of metals are defective in that they are readily oxidized and poor in chemical stability, although they are readily prepared and have proper hardness as the abrasives. The fine spherical particles made of ceramics have too high hardness that they are liable to damage grinding objects, and have drawbacks that they are so fragile that they are readily cracked while it is difficult to prepare the particles by controlling their size. Although the fine particles made of polymers are soft and do not damage the grinding object, they have drawbacks that they are weak against heat and mechanical shock. In addition, these spherical particles are difficult to deform into other shapes, and requires an adhesive or a special heat treatment for bonding the particles to one another.

Accordingly, it is an object of the invention, performed by taking above situations into consideration and for solving the technical problems, to provide chemically stable and soft graphite nanospheres that are useful as abrasives and lubricants and are fine spherical particles of nanometer order. Another object of the invention is to provide a method for preparing the graphite nanospheres that is able to prepare the particles by controlling their diameter and shape.

### DISCLOSURE OF INVENTION

The invention for solving the problems above provides features as described below.

In a first aspect, the invention provides graphite nanospheres having a structure comprising a plurality of pyramids of multilayer graphite disposed with no spaces therebetween with their apexes concentrated at a center, and the overall or partial appearance thereof is almost spherical. In a second aspect, the invention provides the graphite nanospheres having a structure comprising a plurality of frustum of pyramids of multilayer graphite disposed with no spaces therebetween with their apexes concentrated at a center, and the overall or partial appearance thereof is almost spherical hollow nanospheres. And the invention of this application provides the graphite nanospheres which have following features about the graphite nanospheres described above.

In a third aspect, the invention provides the graphite nanospheres having the maximum outer diameter of 1 to 1000 nm. In a fourth and fifth aspect, the appearance of the graphite nanospheres may be almost ellipsoidal spherical and semi-spherical respectively. In the sixth aspect, the c-axis of the graphite layer is aligned within an angle of 90±30° relative to the almost spherical surface.

On the other hand, in a seventh aspect, the invention provides a method for preparing graphite nanospheres by emitting carbon atoms or clusters at a temperature of no less than 1000° C. in an inert gas atmosphere under a pressure of 5 to 10 atm.

In an eighth aspect, carbon atoms or clusters at a temperature of no less than 1000° C. are emitted by irradiating a carbon target with a CO₂ laser in an inert gas atmosphere under a pressure of 5 to 10 atm. In a ninth aspect, the maximum outer diameter of the graphite particles may be controlled by changing the kind of the inert gas, the pressure or the temperature.

In a tenth aspect, the invention provides a method for preparing graphite nanospheres by changing the diameter and shape of the graphite nanospheres by peeling graphite layers of the graphite nanospheres obtained by the method any one of described above. In an eleventh aspect, the graphite nanospheres may be formed into almost ellipsoidal spherical or semi-spherical by peeling the graphite layers of the graphite nanospheres. In a twelfth aspect, the graphite layers may be peeled by agitating the graphite nanospheres dispersed in a solvent, and in a thirteenth aspect, the graphite layers may be peeled by agitation after confining the graphite nanospheres and a gas together in a vessel, or in a fourteenth aspect, the graphite layers may be peeled by grinding the graphite nanospheres sandwiched between two smooth surfaces.

### BRIEF DESCRIPTION OF THE DRAWINGS

FIGS. 1a, 1b and 1c illustrate an example of the appearance, a constituting unit and a cross section of the constituting unit, respectively, of the graphite nanospheres provided by the invention.

FIGS. 2a, 2b and 2c illustrate another example of the entire image, a constituting unit and a cross section of the constituting unit, respectively, of the graphite nanospheres provided by the invention.

FIG. 3 is a photograph showing a scanning electron microscope (SEM) image of the graphite nanospheres according to the invention.

FIG. 4 shows a Raman spectrum of the graphite nanospheres according to the invention.

FIG. 5 is a photograph showing the transmission electron microscope (TEM) image of the graphite nanospheres according to the invention.

FIG. 6 is another photograph showing the transmission electron microscope (TEM) image of the graphite nanospheres according to the invention.

### BEST MODE FOR CARRYING OUT THE INVENTION

The invention featured as described above will be described hereinafter.

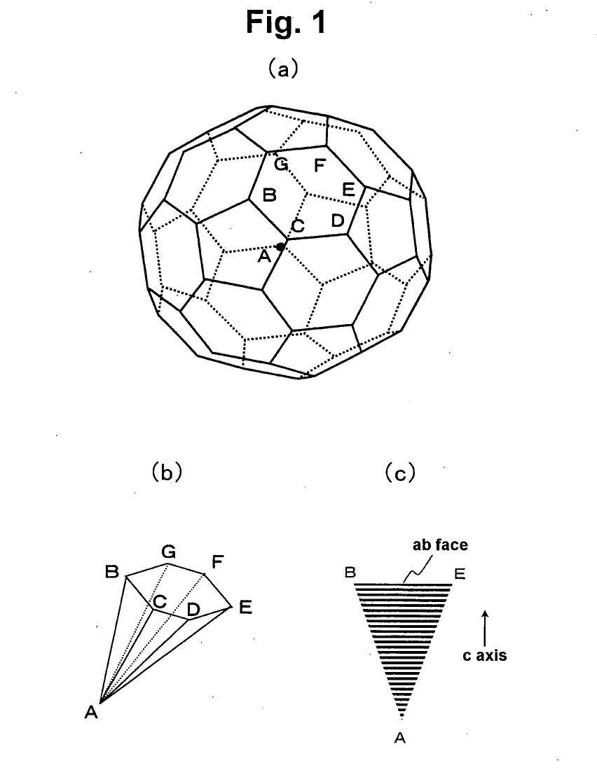

The graphite nanospheres provided by the invention have a structure comprising a plurality of pyramids of multilayer graphite disposed with no spaces therebetween with their apexes concentrated at a center, and overall or partial appearance thereof is almost spherical. FIGS. 1a to 1c each illustrates an example of the structure of the graphite nanospheres.

FIG. 1a is an example showing the appearance of the graphite nanospheres. FIG. 1b shows an appearance of a multilayer graphite as a constituting unit of the graphite nanospheres, and FIG. 1c shows a cross section thereof.

More specifically, the graphite nanospheres of the invention has a constituting unit of multilayer graphite comprising pyramids A-BCDEF as shown in FIG. 1b, and a plurality of the multilayer graphite are disposed with no spaces therebetween with their apexes A concentrated at a center and the bottom faces BCDEFG outside as shown in FIG. 1a. The size of the bottom face of the multilayer graphite (for example the length BE) is supposed to be 50 to 100 nm. The overall appearance thereof is almost spherical as shown in FIG. 1a with a nanometer order diameter of 1 to 1000 nm. The phrase “almost spherical” refers to almost polyhedral form (an approximate polyhedron) in a strict sense, and does not always mean to be almost spherical. However, the appearance is expressed as “almost spherical”, since the overall appearance of the graphite nanospheres of the invention comprising a plurality of the multilayer graphite may be considered to be spherical, and the phrase seems to be most proper for expressing the characteristic appearance of the graphite nanospheres of the invention as a novel graphite structure.

The overall appearance of the graphite nanospheres is almost spherical when the size of the bottom face and the height of each multilayer graphite as a constituting element are almost constant. On the other hand, when the size of the bottom face and the height of each multilayer graphite as a constituting element are different, the graphite nanospheres having various overall appearances may be obtained. For example, the appearance of the graphite nanospheres may be various almost ellipsoidal spheres with a major axis length of 1 to 1000 nm. Otherwise, the graphite nanospheres may have a peculiar shape in which a part of the pyramid as a constituting unit is lost, or may be semi-graphite nanospheres in which half of the sphere is lost.

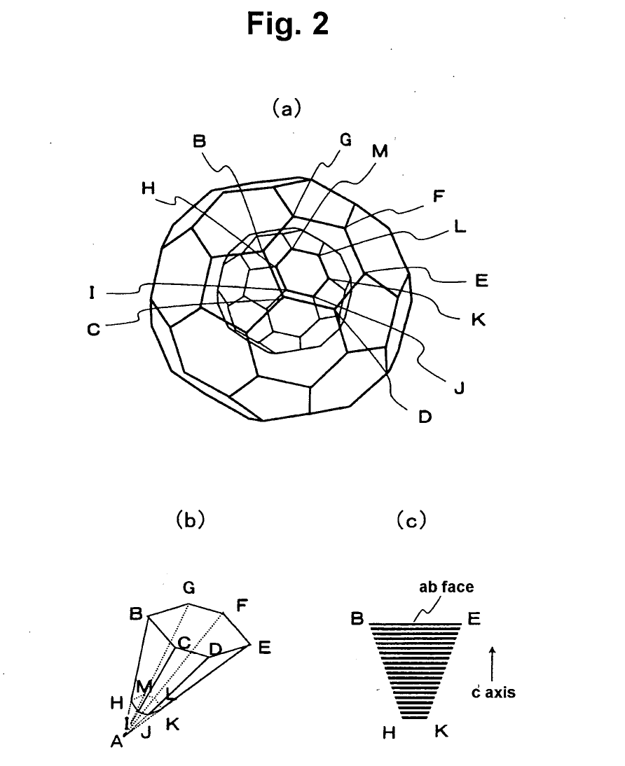

FIGS. 2a to 2c show another example of the structure of the graphite nanospheres in contrast to FIGS. 1a to 1c. Multilayer graphite as a constituting element in the graphite nanospheres assumes a frustum of pyramid HIJKLM-BCDEFG as shown in FIG. 2b. In other words, the apex of the pyramid A-HIJKLM is lost from the pyramid A-BCDEFG in FIG. 1b. The size of the bottom face of the frustum of pyramid of multilayer graphite (for example the length of BE) is considered to be 50 to 100 nm. The frustum of pyramid of multilayer graphite are disposes with no spaces therebetween with their top surface HIJKLM concentrated at a center, and the overall appearance is an almost spherical hollow nanosphere with a diameter of 1 to 1000 nm as shown in FIG. 2a.

The overall appearance of the graphite hollow nanosphere is almost spherical when the size of the bottom face and shape of each multilayer graphite as a constituting element are almost constant to one another, while the graphite nanospheres that are partially spherical and have various shapes as a whole may be obtained when the size and shape of each of the multilayer graphite as a constituting element are different from others. For example, almost ellipsoidal, semi-spherical and peculiarly shaped graphite nanospheres may be obtained.

The ab face of the multilayer graphite nanosphere is parallel to the bottom face BCDEFG as shown FIGS. 1c and 2c in the graphite nanospheres of the invention, and the angle of the c-axis of the crystal relative to the bottom face BCDEFG is within the range of 90±30°. In other word, the c-axis of the graphite layer in the graphite nanospheres of the invention has an angle of 90±30° relative to the surface of the graphite nanospheres.

FIGS. 1b and 2b show the examples when the shape of the bottom face of the pyramid or frustum of pyramid is a hexagonal shape BCDEFG. While each layer of the multilayer graphite is mostly hexagonal since the graphite crystal belongs to the hexagonal crystal system, the shape of the bottom face of the pyramid or frustum of pyramid of graphite layer as the constituting element is not always restricted to hexagonal. The shape of each graphite layer as the constituting unit is not always required to be the same as the shape of the others, and various shapes such as pyramid and frustum of pyramid may be mixed together.

Each graphite layer may be bonded to others by either a Van der Waals' force or chemical bond in the graphite nanospheres of the invention. The chemical bond may be a bond between sp2 six-membered rings at the ends of the graphite layers belonging to different constituting units, or may be a chemical bond other than the bond between the sp2 six-membered rings.

The graphite nanospheres of the invention may be prepared by a method for preparing the graphite nanospheres of the invention, wherein carbon atoms or clusters at a temperature of no less than 1000° C. are emitted in an inert gas atmosphere under a pressure of 5 to 10 atm.

In an example of favorable methods, carbon atoms or clusters at a temperature of no less than 1000° C. are emitted by irradiating a carbon target with a CO₂ laser in an inert gas atmosphere under a pressure of 5 to 10 atm. Examples of the inert gas available include rare gases such as He, Ar and Ne.

It is possible in the invention to control the maximum outer diameter of the graphite nanospheres by changing the kind of the inert gas, pressure and temperature. The maximum outer diameter of the graphite nanospheres can be reduced as the inert gas used has a smaller molecular weight, the pressure of the inert gas is reduced in the range of 5 to 10 atm, and the temperature of the inert gas is lowered in the range of 1700 to 20° C.

The conditions above permit almost spherical graphite nanospheres and almost spherical hollow graphite nanospheres to be simultaneously obtained.

The appearance of the graphite nanospheres of the invention may be formed into various structures such as an almost ellipsoidal spherical and a semi-spherical. For example, the almost ellipsoidal spherical graphite nanospheres may be prepared by peeling the surface layer of the multilayer graphite as the constituting element of the almost spherical graphite nanospheres so that the overall shape is ellipsoidal spherical. The graphite nanospheres having various sizes and shapes may be obtained depending on the number and positions of the graphite layers. It is needless to say that the graphite nanospheres having a smaller maximum outer diameter can be prepared by evenly peeling the graphite layers on the surface of the almost spherical graphite nanospheres. Semi-spherical graphite nanospheres may be also prepared by peeling about half of the pyramid formed graphite layers as the constituting element of the graphite nanospheres.

Various methods may be devised for peeling the graphite layers. For example, one to several layers of the surface graphite layers may be peeled by dispersing the graphite nanospheres in a solvent, and vigorously agitating the dispersion with a vibrator. Examples of the solvent available include inorganic solvents such as water, carbon disulfide and acids, organic solvents such as hydrocarbons including benzene, toluene and xylene, and alcohols, ethers and derivatives thereof, polymers such as polymethacrylic acid methyl(PMMA) polyethylene (PE) and polyvinyl chloride (PVC), and mixtures thereof. One to several layers of the surface graphite layers may be also peeled by confining the graphite nanospheres and a gas such as an inert gas, nitrogen or oxygen together in a vessel, and by vigorously agitating the spheres. A crusher with a rotation speed of about 1,500 rpm may be conveniently used for agitating.

In a different method, one to several graphite layers may be peeled by placing the graphite nanospheres between two smooth planes so as to sandwich the graphite nanospheres, and allowing the two smooth planes to move so as to grind the graphite nanospheres.

The graphite nanospheres having various shapes may be prepared by the method according to the invention.

The maximum outer diameter of the graphite nanospheres of the invention thus obtained can be readily controlled in the range of 1 to 1000 nm, and many applications are possible as quite novel fine spheres having a size of nanometer order. The graphite nanospheres are stable at high temperatures due to their graphite layer structures while they are resistant to chemical corrosion. Furthermore, the graphite nanospheres are neither so rigid and fragile as ceramics nor soft as polymers, and are provided with an appropriate hardness and mechanical strength. Accordingly, the graphite nanospheres of the invention are useful as, for example, abrasives and lubricants by providing quite new graphite materials.

The embodiment of the invention will be described in more detail with reference to the example below.

### EXAMPLES

Carbon atoms or clusters at a temperature of no less than 4,000° C. are emitted by irradiating a carbon target with a high power CO₂ laser with an energy of 25 W/cm² in an argon gas atmosphere under a pressure changing in the range of 5 to 10 atm, and the product was retrieved by quenching the emitted carbon atoms or clusters.

It was confirmed by an observation of the product with an electron microscope that graphite nanospheres with an almost uniform size were obtained. It was also confirmed that the diameter of the graphite nanospheres increases from about 100 nm to about 700 nm as the pressure of the argon atmosphere is elevated from 5 atm to 10 atm.

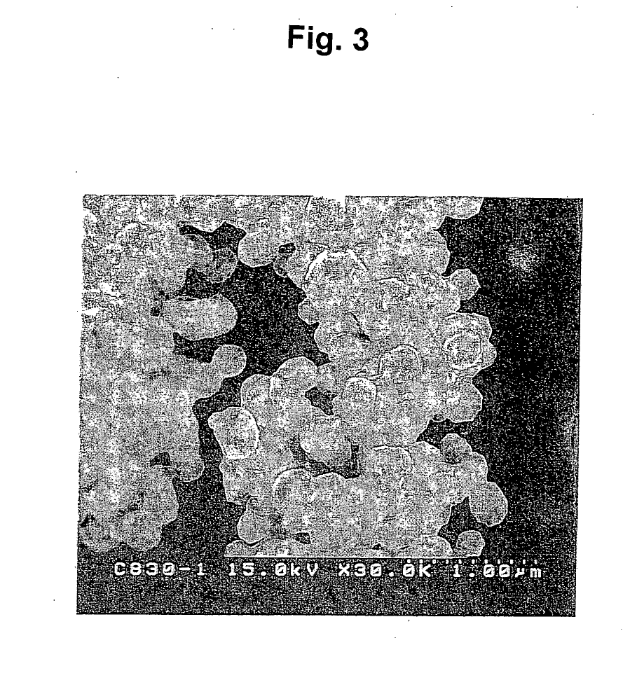

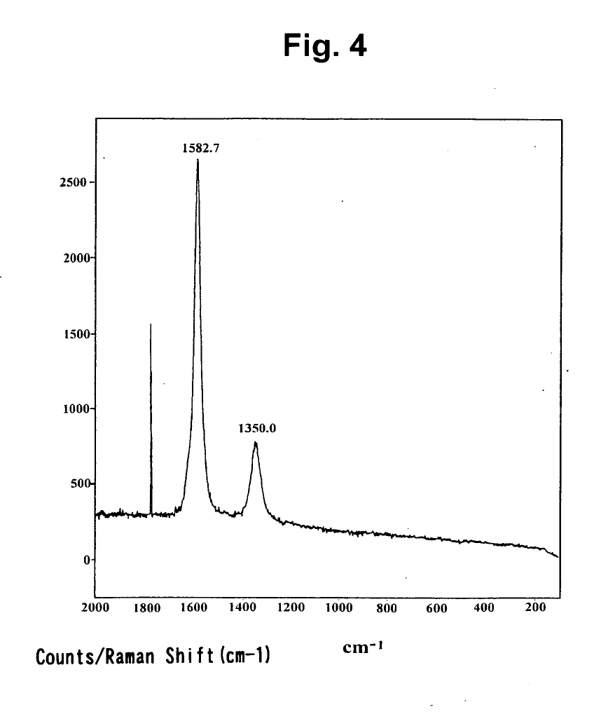

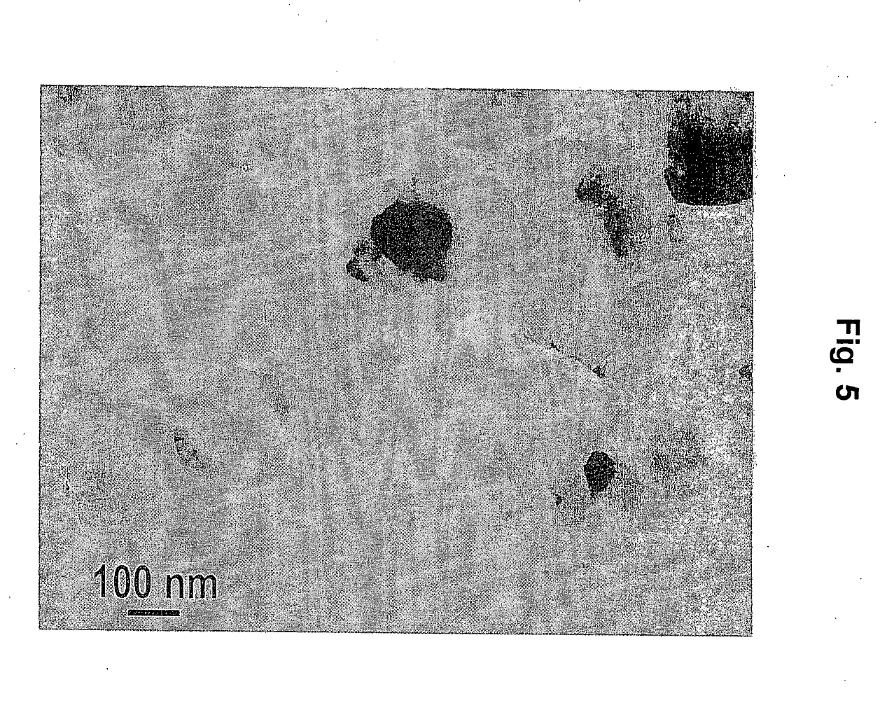

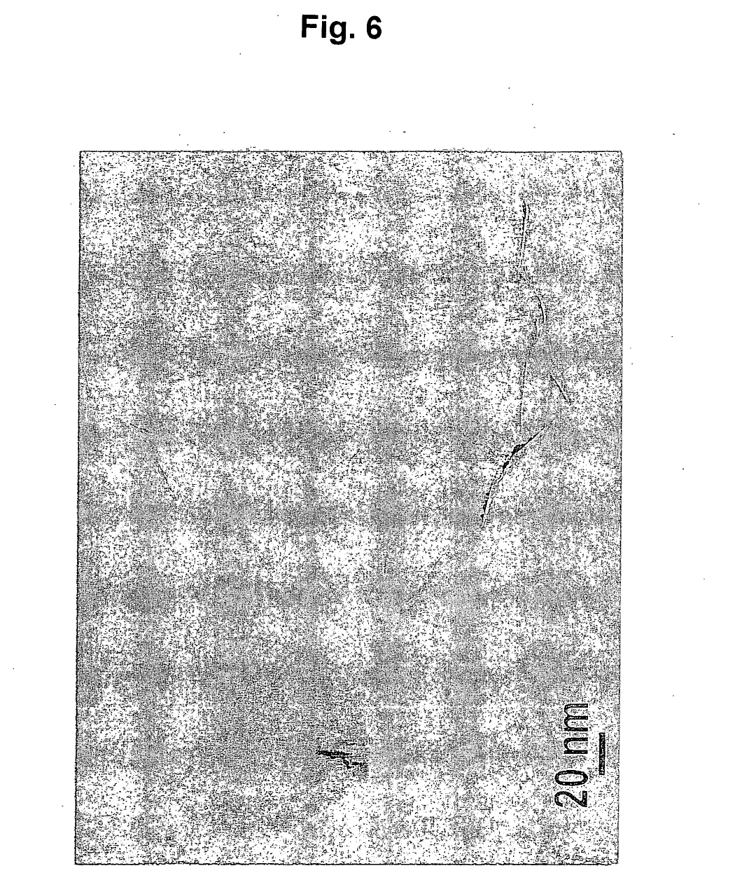

A scanning electron microscope (SEM) image of the graphite nanospheres obtained at an argon atmosphere pressure of 8 atm is shown in FIG. 3. The purity of the graphite nanospheres was 90%, while the yield was 90%. FIG. 4 shows the Raman spectrum of the graphite nanospheres, and FIGS. 5 and 6 show a transmission electron microscope (TEM) image. Peaks specific to graphite were observed at near 1582 and 1350 cm⁻¹ in the Raman spectrum in FIG. 4, and the graphite nanospheres were confirmed to be pure graphite. It was confirmed from FIGS. 5 and 6 that there are a number of graphite faces on the surface of the graphite nanospheres. The size of the graphite surface is supposed to be 50 to 100 nm, by the twp peaks of Raman spectrum, which is consistent with the TEM image in FIG. 6.

It is needless to say that the invention is not restricted to the examples above, and various modifications of the embodiment are possible with respect to the details of the invention.

### INDUSTRIAL APPLICABILITY

As hiterto described in detail, the invention provides chemically stable and soft graphite nanospheres, which are useful as abrasives and lubricants and, that are fine spheres with a nanometer order. The invention also provides a method for preparing the graphite nanospheres that are able to be prepared by controlling their diameter and shape.

1. Graphite nanospheres having a structure comprising a plurality of pyramids of multilayer graphite disposed with no spaces therebetween with their apexes concentrated at a center,
overall or partial appearance thereof being almost spherical.

2. Graphite nanospheres having a structure comprising a plurality of frustum of pyramids of multilayer graphite disposed with no spaces therebetween with their apexes concentrated at a center,
overall or partial appearance thereof being almost spherical hollow nanosheres.

3. The graphite nanospheres according to claim 1, wherein the maximum outer diameter is 1 to 1000 nm.

4. The graphite nanospheres according to claim 1, wherein the appearance is almost ellipsoidal spherical.

5. The graphite nanospheres according to claim 1, wherein the appearance is almost semi-spherical.

6. The graphite nanospheres according to claim 1, wherein the c-axis of the graphite layer is aligned within an angle of 90±30° relative to the almost spherical surface.

7. A method for preparing graphite nanospheres according to claim 1,
carbon atoms or clusters at a temperature of no less than 1000° C. being emitted in an inert gas atmosphere under a pressure of 5 to 10 atm.

8. The method according to claim 7 for preparing graphite nanospheres, wherein carbon atoms or clusters at a temperature of no less than 1000° C. are emitted by irradiating a carbon target with a CO₂ laser in an inert gas atmosphere under a pressure of 5 to 10 atm.

9. The method according to claim 7 for preparing graphite nanospheres, wherein the maximum outer diameter of the graphite particles is controlled by changing the kind of the inert gas, the pressure or the temperature.

10. A method for preparing graphite nanospheres, wherein the maximum outer diameter and shape of the graphite nanospheres are changed by peeling graphite layers of the graphite nanospheres obtained by the method according to claim 7.

11. The method according to claim 10 for preparing graphite nanospheres formed into almost ellipsoidal spherical or semi-spherical by peeling the graphite layers of the graphite nanospheres.

12. The method according to claim 10 for preparing graphite nanospheres, wherein the graphite layers are peeled by agitating the graphite nanospheres dispersed in a solvent.

13. The method according to claim 10 for preparing graphite nanospheres, wherein the graphite layers are peeled by agitation after confining the graphite nanospheres and a gas together in a vessel.

14. The method according to claim 10 for preparing graphite nanospheres, wherein the graphite layers are peeled by grinding the graphite nanospheres sandwiched between two smooth surfaces.
